(19) United States
(12) Patent Application Publication
(10) Pub. No.: US 2023/0373203 A1
(43) Pub. Date: Nov. 23, 2023

(54) APPARATUS FOR MANUFACTURING DISPLAY DEVICE AND METHOD OF MANUFACTURING DISPLAY DEVICE

(71) Applicant: SAMSUNG DISPLAY CO., LTD., Yongin-si (KR)

(72) Inventors: Dongho PARK, Yongin-si (KR); Tetsuya OKAMOTO, Yongin-si (KR); Junhee LEE, Yongin-si (KR); Dongmin PARK, Yongin-si (KR); Junghyeok LIM, Yongin-si (KR)

(21) Appl. No.: 18/141,271

(22) Filed: Apr. 28, 2023

(30) Foreign Application Priority Data
May 17, 2022 (KR) 10-2022-0060444
Oct. 26, 2022 (KR) 10-2022-0139627

(51) Int. Cl. B32B 37/02; B32B 37/10; B32B 38/18

(52) U.S. Cl. CPC B32B 37/02; B32B 37/1018; B32B 38/18; B32B 2457/206

(57) ABSTRACT

An apparatus for manufacturing a display device includes a pressurizing portion and a first unit arranged apart from the pressurizing portion in a first direction when the first unit is in a first position, where the first unit includes a first support portion movable in the first direction, a first chamber arranged on the first support portion, where a first substrate is loaded in the first chamber, and a second chamber arranged on the first chamber, where a second substrate is loaded in the second chamber, and the first support portion moves between the first position in which the first support portion is located apart from the pressurizing portion in the first direction and a second position in which the first support portion and the pressurizing portion overlap each other in a plan view.

This application claims priority to Korean Patent Application No. 10-2022-0060444, filed on May 17, 2022, and Korean Patent Application No. 10-2022-0139627, filed on Oct. 26, 2022, and all the benefits accruing therefrom under 35 U.S.C. § 119, the contents of which in their entireties are herein incorporated by reference.

### BACKGROUND

### 1. Field

One or more embodiments relate to an apparatus for manufacturing a display device and a method of manufacturing a display device, and more particularly, to an apparatus for manufacturing a display device and a method of manufacturing a display device with improved process efficiency.

### 2. Description of the Related Art

Recently, electronic devices have been widely used in various fields. Electronic devices are used for various purposes as mobile electronic devices and fixed electronic devices, and may include a display device capable of providing visual information such as an image or a video to a user to support various functions.

As other components for driving display devices decrease in size, areas occupied by the display devices in the electronic devices tend to increase, and structures, which are bendable from a flat state to have certain angles or foldable with respect to an axis, have been developed.

### SUMMARY

Display devices may be manufactured by bonding a cover window and/or an adhesive film onto a substrate in which a plurality of layers are stacked. In a manufacturing process of such display devices, it may be desired to improve process time and process efficiency through simplification of procedures in a process of loading and bonding objects.

One or more embodiments include an apparatus for manufacturing a display device and a method of manufacturing a display device with improved process efficiency.

According to one or more embodiments, an apparatus for manufacturing a display device includes a pressurizing portion and a first unit arranged apart from the pressurizing portion in a first direction when the first unit is in a first position, where the first unit includes a first support portion movable in the first direction, a first chamber arranged on the first support portion, where a first substrate is loaded in the first chamber, and a second chamber arranged on the first chamber, where a second substrate is loaded in the second chamber, and the first support portion moves between the first position in which the first support portion is apart from the pressurizing portion in the first direction and a second position in which the first support portion and the pressurizing portion overlap each other in a plan view.

In an embodiment, when the first support portion is in the first position, the first substrate and the second substrate may be simultaneously loaded to the first chamber and the second chamber, respectively.

In an embodiment, when the first support portion is in the second position, the pressurizing portion may apply pressure to at least one selected from the first chamber and the second chamber.

In an embodiment, the apparatus may further include a vacuum portion arranged apart from the first unit in the first direction, where, when the first support portion is in the second position, the vacuum portion is docked to the first chamber.

In an embodiment, when the first support portion is in the first position, the vacuum portion may be undocked from the first chamber.

In an embodiment, the first chamber and the second chamber may move relatively with respect to each other from a first chamber position in which the first chamber and the second chamber do not overlap each other in the plan view, to a second chamber position in which the first chamber and the second chamber overlap each other in the plan view.

In an embodiment, the first substrate and the second substrate may be loaded to or released from the first chamber and the second chamber, respectively, when the first chamber and the second chamber are in the first chamber position.

In an embodiment, the first unit may further include chamber driving portions respectively arranged on opposing sides of the first chamber, and a bridge portion extending between the chamber driving portions and connected to the chamber driving portions, wherein the second chamber is connected to the bridge portion and is moved vertically with respect to the bridge portion to form a sealed space together with the first chamber when the first chamber and the second chamber are in the second chamber position.

In an embodiment, the apparatus may further include a second unit arranged opposite to the first unit with respect to the pressurizing portion, where the first unit and the second unit alternately move towards the pressurizing portion in a way such that the second unit is in a third position in which the second unit is located apart from the pressurizing portion when the first unit is in the first position, and the second unit is in a fourth position in which the second unit overlaps the pressurizing portion in the plan view when the first unit is in the second position.

In an embodiment, the second unit may include a second support portion movable in the first direction, a third chamber arranged on the second support portion, where a third substrate is loaded in the third chamber, and a fourth chamber arranged on the third chamber, where a fourth substrate is loaded in the fourth chamber, and when the first support portion is in the second position, the second support portion is in the third position.

In an embodiment, the first unit may be pressurized by the pressurizing portion when the first support portion is in the second position, and the third substrate and the fourth substrate may be simultaneously loaded to the second unit when the second support portion is in the third position.

In an embodiment, the apparatus may further include a vacuum portion arranged apart from and between the first unit and the second unit, where the first unit may be docked to the vacuum portion and the second unit may be undocked from the vacuum portion when the first unit is in the second position and the second unit is in the fourth position, and the first unit may be undocked from the vacuum portion and the second unit may be docked to the vacuum portion when the first unit is in the first position and the second unit is in the third position.

According to one or more embodiments, a method of manufacturing a display device includes loading a plurality of substrates to be bonded to each other to a first unit in a first position in which the first unit is located apart from a pressurizing portion in a first direction, moving the first unit to a second position in which the first unit and the pressurizing portion overlap each other in a plan view, pressurizing, by the pressurizing portion, the first unit in the second position to bond the plurality of substrates to each other, moving the first unit to the first position, and releasing the plurality of substrates bonded to each other from the first unit in the first position, and re-loading a plurality of substrates to be bonded to the first unit in the first position.

In an embodiment, the loading the plurality of substrates to be bonded to each other to the first unit may include simultaneously loading the plurality of substrates to the first unit.

In an embodiment, the first unit may include a first chamber and a second chamber arranged on the first chamber, the first chamber and the second chamber may be located at a first chamber position in which the first chamber and the second chamber do not overlap each other in the plan view, and the plurality of substrates may be loaded simultaneously when the first chamber and the second chamber are in the first chamber position.

In an embodiment, the first unit may include a first chamber and a second chamber arranged on the first chamber, and the first chamber and the second chamber may be located at a second chamber position in which the first chamber and the second chamber are disposed to overlap each other to seal a space therein.

In an embodiment, when the first chamber and the second chamber are in the second chamber position, the pressurizing portion may pressurize the second chamber to bond the plurality of substrates loaded to the first chamber and the second chamber.

In an embodiment, the method may further include docking a vacuum portion to the first unit to form a vacuum inside the first unit when the first unit is in the second position.

In an embodiment, the method may further include pressurizing, by the pressurizing portion, the second unit in a third position, in which the second unit and the pressurizing portion overlap each other in the plan view, to bond a plurality of substrates loaded to the second unit during when the plurality of substrates to be bonded to each other are loaded to the first unit in the first position.

In an embodiment, the method may further include moving the second unit to a fourth in which the second unit is located position apart from the pressurizing portion during when the first unit is moved to the second position.

In an embodiment, the method may further include releasing the plurality of substrates bonded to each other from the second unit in the fourth position and re-loading a plurality of substrates to be bonded to the second unit during when the first unit in the second position is pressurized by the pressurizing portion.

Features of embodiments other than those described above will become apparent from the following detailed description, the appended claims, and the accompanying drawings.

### BRIEF DESCRIPTION OF THE DRAWINGS

The above and other features of certain embodiments of the disclosure will be more apparent from the following description taken in conjunction with the accompanying drawings, in which:

FIG. 1 is a schematic perspective view of an apparatus for manufacturing a display device, according to an embodiment;

FIG. 2 is a schematic view seen in an II direction and focused on a second chamber of an apparatus for manufacturing a display device according to an embodiment;

FIG. 3 is a cross-sectional view taken along line III-III′ of FIG. 2 to illustrate a first unit according to an embodiment;

FIG. 4 is a cross-sectional view taken along line IV-IV′ of FIG. 2 to illustrate a first unit according to an embodiment;

FIG. 5 is a schematic view taken along line V-V′ of FIG. 1 to illustrate a vacuum portion according to an embodiment;

FIGS. 6 to 8 are schematic diagrams illustrating a method of manufacturing a display device, according to an embodiment;

FIG. 9 is a schematic perspective view of an apparatus for manufacturing a display device, according to an alternative embodiment;

FIGS. 10 and 11 are schematic diagrams illustrating a method of manufacturing a display device, according to an alternative embodiment;

FIG. 12 is a plan view schematically illustrating a display device according to an embodiment; and

FIG. 13 is a schematic cross-sectional view of a display device manufactured by an apparatus for manufacturing a display device, according to an embodiment.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. Throughout the disclosure, the expression “at least one of a, b or c” or “at least one selected from a, b and c” indicates only a, only b, only c, both a and b, both a and c, both b and c, all of a, b, and c, or variations thereof.

The disclosure may include various embodiments and modifications, and certain embodiments thereof are illustrated in the drawings and will be described herein in detail. The effects and features of the disclosure and the accomplishing methods thereof will become apparent from the embodiments described below in detail with reference to the accompanying drawings. However, the disclosure is not limited to the embodiments described below and may be embodied in various modes.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

It will be understood that when a layer, region, or component is referred to as being “on” another layer, region, or component, it may be “directly on” the other layer, region, or component or may be “indirectly on” the other layer, region, or component with one or more intervening layers, regions, or components therebetween.

Sizes of components in the drawings may be exaggerated for convenience of description. In other words, because the sizes and thicknesses of components in the drawings are arbitrarily illustrated for convenience of description, the disclosure is not limited thereto.

In the following embodiments, the x-axis, the y-axis and the z-axis are not limited to three axes of the rectangular coordinate system, and may be interpreted in a broader sense. For example, the x-axis, the y-axis, and the z-axis may be perpendicular to one another, or may represent different directions that are not perpendicular to one another.

When a certain embodiment may be implemented differently, a specific process order may be performed differently from the described order. For example, two processes described in succession may be performed substantially simultaneously, or may be performed in an order opposite to that described.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

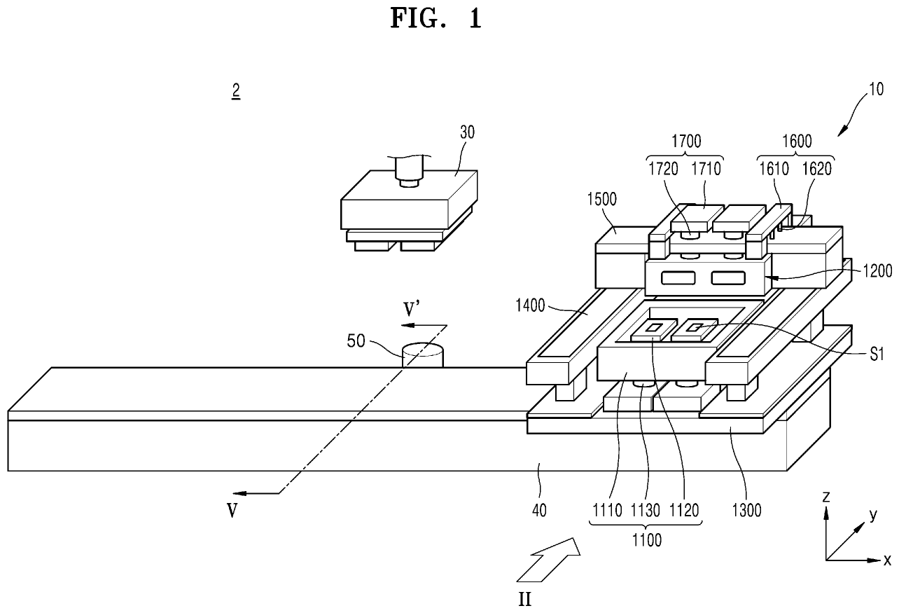

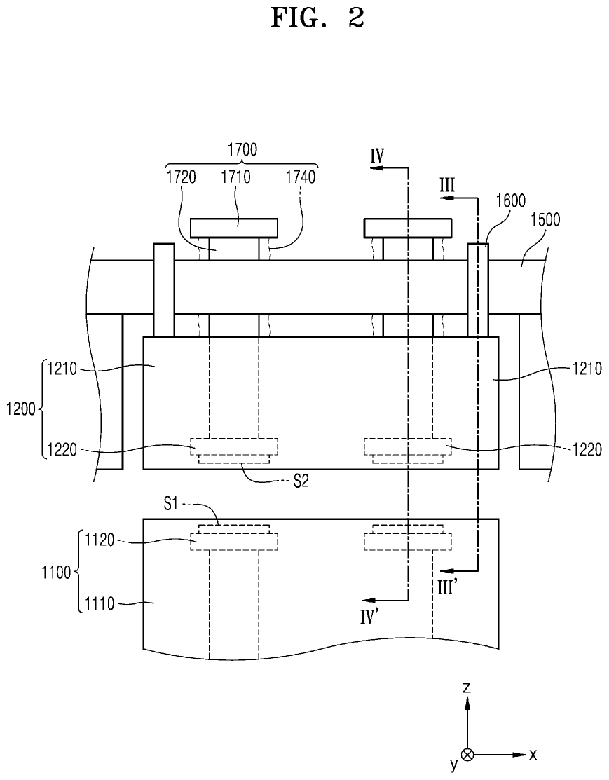

FIG. 1 is a schematic perspective view of an apparatus for manufacturing a display device, according to an embodiment. FIG. 2 is a schematic view seen in an II direction and focused on a second chamber of an apparatus for manufacturing a display device according to an embodiment. An apparatus for manufacturing a display device according to an embodiment may be used for bonding various substrates.

With reference to FIG. 1, an embodiment of an apparatus for manufacturing a display device 2 may include a support driving portion 40, a first unit 10, a pressurizing portion 30, and a vacuum portion 50.

The support driving portion 40 may support the first unit 10. In an embodiment, the support driving portion 40 may extend lengthwise in a first direction (e.g., x direction of FIG. 1), and may move the first unit 10 along with an extension direction of the support driving portion 40, i.e., along the first direction. The support driving portion 40 may be, for example, in a form of a rail such that the first unit 10 fixed to the rail is moved as the rail moves. Alternatively, the support driving portion 40 may be in a form of a shuttle robot to move the first unit 10; however, the form of the support driving portion 40 is not limited thereto, and various methods may be adopted within the technical idea of the disclosure.

The support driving portion 40 may move the first unit 10 between a first position and a second position, which are to be described in detail below. The first position may refer to a substrate supplying position at which the first unit 10 is arranged apart from the pressurizing portion 30 in the first direction. In an embodiment, the second position may be a bonding position at which the first unit 10 is moved to overlap the pressurizing portion 30 in a plan view.

The first unit 10 may include a first support portion 1300, a first chamber 1100, and a second chamber 1200. The first support portion 1300 may be connected to the support driving portion 40 or may be arranged on the support driving portion 40 to move along the support driving portion 40. In an embodiment, the first support portion 1300 may move in the extension direction of the support driving portion 40, that is, the first direction. In an embodiment, the first support portion 1300 may slide in the extension direction of the support driving portion 40.

The first chamber 1100 may be arranged (or disposed) on the first support portion 1300. The first chamber 1100 may include a first housing 1110 and a first stage 1120. The first housing 1110 may define an inner accommodation space with one open side and form an exterior of the first chamber 1100. In the inner accommodation space, the first stage 1120 may be arranged towards the one open side (e.g., in +z direction of FIG. 1.) In an embodiment, a single first stage 1120 may be arranged in the inner accommodation space of the first housing 1110, but not being limited thereto. In an alternative embodiment, a plurality of separate first stages 1120 may be arranged in the inner accommodation space of the first housing 1110. Hereinafter, for convenience of description, embodiments where a plurality of separate first stages 1120 is arranged in the inner accommodation space of the first housing 1110 will be described in detail.

The first stage 1120 may accommodate a first substrate S1. In an embodiment, the first substrate S1 may be provided and loaded on the first stage 1120. In an embodiment, the first stage 1120 may include an electrostatic chuck and may electrostatically adsorb the first substrate S1 by electrostatic force. Alternatively, the first stage 1120 may be connected to an adsorption pump, and adsorb the first substrate S1 when the adsorption pump is driven. An adsorption side of the first stage 1120 may be directed upwards (e.g., +z direction of FIG. 1), that is, towards the second chamber 1200 to be described. In an embodiment where a plurality of first stages 1120 is arranged in the inner accommodation space of the first housing 1110, a plurality of first substrates S1 may respectively be adsorbed and accommodated by the plurality of first stages 1120. In such an embodiment, the first substrate S1 may be one of a display panel for a display device, a metal plate, and an adhesive film.

The second chamber 1200 may be arranged on the first chamber 1100 (e.g., in +z direction of FIG. 1.) The second chamber 1200 may include a second housing 1210 and a second stage 1220. The second housing 1210 may define an inner accommodation space with one open side and form an exterior of the second chamber 1200. In the inner accommodation space, the second stage 1220 may be arranged towards the one open side (e.g., in −z direction of FIG. 1.) In an embodiment, a single second stage 1220 may be arranged in the inner accommodation space of the second housing 1210, but not being limited thereto. In an alternative embodiment, a plurality of separate second stages 1220 may be arranged in the inner accommodation space of the second housing 1210. The number of the second stage 1220 may be identical to the number of the first stage 1120, and accordingly, a plurality of substrates may correspond and be bonded to each other. Hereinafter, embodiments where a plurality of separate second stages 1220 is arranged in the inner accommodation space of the second housing 1210, and the number of the second stages 1220 are identical to the number of the first stages 1120 will be described in detail.

The second stage 1220 may accommodate a second substrate S2. In an embodiment, the second substrate S2 may be provided and loaded on the second stage 1220. In an embodiment, the second stage 1220 may include an electrostatic chuck and may electrostatically adsorb the second substrate S2 by electrostatic force. Alternatively, the second stage 1220 may be connected to an adsorption pump, and adsorb the second substrate S2 when the adsorption pump is driven. An adsorption side of the second stage 1220 may be directed downwards (e.g., −z direction of FIG. 1), that is, towards the first chamber 1100. In an embodiment where a plurality of second stages 1220 is arranged in the inner accommodation space of the second housing 1210, a plurality of second substrates S2 may respectively be adsorbed and accommodated by the plurality of second stages 1220. In such an embodiment, the second substrate S2 may be one of a cover window for a display device, an adhesive film, and a display panel.

The second chamber 1200 may be arranged not to overlap the first chamber 1100 in a plan view. In an embodiment, for example, the second chamber 1200 may be arranged apart from the first chamber 1100 in a second direction (e.g., y direction of FIG. 1) intersecting with the first direction (e.g., x direction of FIG. 1.) As such, as the second chamber 1200 is arranged not to overlap the first chamber 1100 on a plan view, the second substrate S2 and the first substrate S1 may be loaded to the second stage 1220 and the first stage 1120, respectively.

In an embodiment, the second chamber 1200 may move between a first chamber position and a second chamber position. In such an embodiment, the first chamber position is a position at which the second chamber 1200 does not overlap the first chamber 1100 on a plan view, that is, a position at which the second chamber 1200 is arranged apart from the first chamber 1100 in the second direction. The second chamber position may be a position at which the second chamber 1200 overlaps the first chamber 1100 on a plan view, that is, a position at which the second chamber 1200 is arranged on the first chamber 1100.

The first unit 10 may further include a chamber driving portion 1400 and a bridge portion 1500. in an embodiment, the second chamber 1200 may be connected to the bridge portion 1500, and the bridge portion 1500 may move between the first chamber position and the second chamber position on the chamber driving portion 1400.

The chamber driving portion 1400 may move the bridge portion 1500 and the second chamber 1200 connected to the bridge portion 1500. In an embodiment, the chamber driving portion 1400 may be a rail extending lengthwise in a movement direction of the second chamber 1200, i.e., the second direction. Alternatively, in another embodiment, the chamber driving portion 1400 may be a shuttle robot extending lengthwise in the second direction and may move the bridge portion 1500 and the second chamber 1200 in the second direction. Hereinafter, embodiments where the chamber driving portion 1400 is a rail extending lengthwise in the second direction will be described in detail.

In an embodiment, two chamber driving portions 1400 may be arranged apart from each other in a movement direction of the second chamber 1200, i.e., a direction intersecting with the second direction. In an embodiment, for example, two chamber driving portions 1400 may respectively arranged on opposing sides of the first chamber 1100 and/or the second chamber 1200, for example, in the first direction. The bridge portion 1500 may be arranged crossing between the two chamber driving portions 1400. Opposing ends of the bridge portion 1500 may be connected to the chamber driving portion 1400, and the bridge portion 1500 may be moved by the chamber driving portion 1400 in the second direction. The second chamber 1200 connected to the bridge portion 1500 may move along with the bridge portion 1500 in the second direction as the bridge portion 1500 is moved in the second direction. Accordingly, the second chamber 1200 may move from the first chamber position to the second chamber position. In an embodiment, the first chamber 1100 may be fixed (i.e., fixed in a predetermined position on the first support portion 1300), and the second chamber 1200 may move between the first chamber position and the second chamber position, the disclosure is not limited thereto. In an alternative embodiment, for example, the second chamber 1200 may be fixed, and the first chamber 1100 may move between the first chamber position and the second chamber position. In such an embodiment, the first chamber 1100 and the second chamber 1200 may move relatively in the second direction.

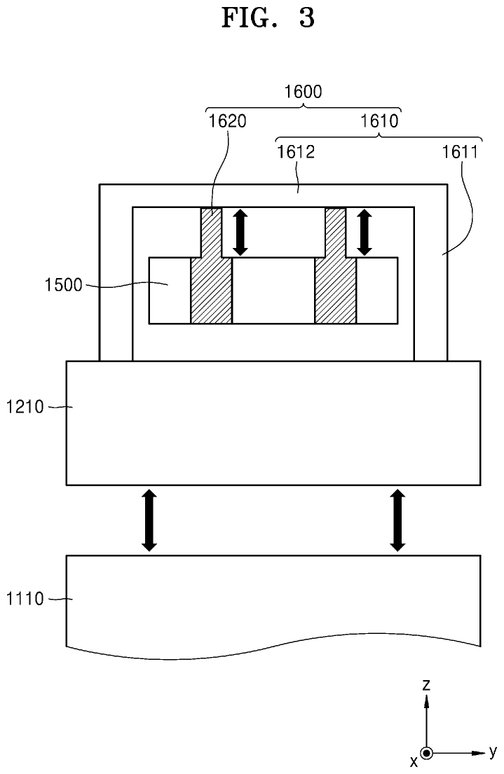

FIG. 3 is a cross-sectional view taken along line III-III′ of FIG. 2 to illustrate a first unit according to an embodiment. FIG. 3 illustrates an embodiment where the second chamber 1200 is moved to the second chamber position, i.e., a position at which the second chamber 1200 is arranged on the first chamber 1100 such that the second chamber 1200 overlaps the first chamber 1100 in a plan view.

With reference to FIGS. 2 and 3, in an embodiment, the second chamber 1200 may further include a housing driving portion 1600. The housing driving portion 1600 may drive vertical movement of a housing, more specifically, vertical movement of the second housing 1210. In an embodiment, the housing driving portion 1600 may include a frame 1610 and a first elastic member 1620. The frame 1610 may be arranged to surround at least a part of the bridge portion 1500. In an embodiment, for example, the frame 1610 may be formed to surround an upper surface of the bridge portion 1500. In such an embodiment, the frame 1610 may include two vertical beams 1611 and a horizontal beam 1612 connecting the two vertical beams 1611 to each other, and the bridge portion 1500 may be arranged in a direction penetrating between the two vertical beams 1611. The frame 1610, more particularly, the two vertical beams 1611 may be connected to the second housing 1210 and fixed to the second housing 1210. Accordingly, when the frame 1610 moves, the second housing 1210 may move along with the frame 1610. In an embodiment, the housing driving portion 1600 may include a single frame 1610 or a plurality of frames 1610, e.g., two frames arranged apart from each other in the first direction as illustrated in FIG. 1.

The first elastic member 1620 may be connected to the frame 1610, for example, to the horizontal beam 1612. One end of the first elastic member 1620 may be connected to the horizontal beam 1612 and another end (or an opposing end) of the first elastic member 1620 may be connected to the bridge portion 1500. The length of the first elastic member 1620 may vary between the horizontal beam 1612 and the bridge portion 1500, and accordingly, the frame 1610 may move vertically. Moreover, according to the vertical movement of the frame 1610, the second housing 1210 connected to the frame 1610 may move vertically as well. In an embodiment, the first elastic member 1620 may include a cylinder. In such an embodiment, when the cylinder is driven by fluid pressure or a motor, the length of the cylinder may be extended or reduced. As such, the second housing 1210 may be vertically driven by the housing driving portion 1600, and for example, the second housing 1210 may move downward towards the first housing 1110 and form a seal (or a sealed space) together with the first housing 1110.

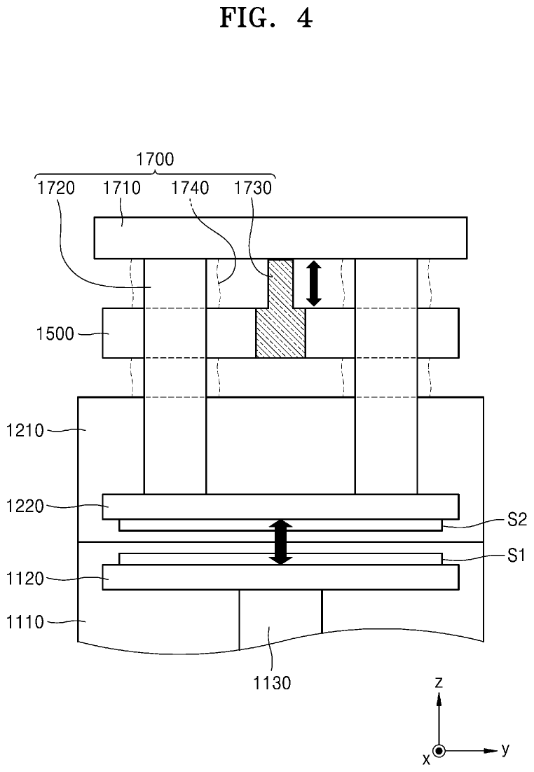

FIG. 4 is a cross-sectional view taken along line IV-IV′ of FIG. 2 to illustrate a first unit according to an embodiment. FIG. 4 illustrates a case where the second chamber 1200 is moved to the second chamber 1200, i.e., a position at which the second chamber 1200 is arranged on the first chamber 1100 such that the second chamber 1200 overlaps the first chamber 1100 in a plan view.

With reference to FIGS. 2 and 4, the second chamber 1200 may further include a stage driving portion 1700. The stage driving portion 1700 may drive vertical movement of a stage, more specifically, vertical movement of the second stage 1220. In an embodiment, the stage driving portion 1700 may include a pressure receiving portion 1710, a shaft 1720, a second elastic member 1730, and a driving bellows 1740. When the pressurizing portion 30 applies pressure to the pressure receiving portion 1710, the pressure receiving portion 1710 may be in contact with the pressurizing portion 30 and may receive pressure from the pressurizing portion 30. In an embodiment, the pressure receiving portion 1710 may include a cushion layer, for example, a pad.

The shaft 1720 may connect the pressure receiving portion 1710 with the second stage 1220. In an embodiment, for example, one end of the shaft 1720 may be connected and fixed to the pressure receiving portion 1710 and another end of the shaft 1720 may be connected and fixed to the second stage 1220. The shaft 1720 may penetrate (or be disposed through) the bridge portion 1500 and the second housing 1210, and when the pressure receiving portion 1710 is pressurized by the pressurizing portion 30 and is moved downwards, the shaft 1720 may penetrate the bridge portion 1500 and move downwards. Accordingly, the second stage 1220 connected and fixed to the shaft 1720 may be moved downwards as well. In an embodiment, the shaft 1720 may be arranged at each second stage 1220; however, in an alternative embodiment, two or more shafts 1720 may be arranged at each second stage 1220 as illustrated in FIG. 4.

The second elastic member 1730 may be connected to the pressure receiving portion 1710. In an embodiment, one end of the second elastic member 1730 may be connected to the pressure receiving portion 1710 and another end of the second elastic member 1730 may be connected to the bridge portion 1500. The length of the second elastic member 1730 may vary between the pressure receiving portion 1710 and the bridge portion 1500. In an embodiment, for example, when the pressure receiving portion 1710 is not pressurized by the pressurizing portion 30, the length of the second elastic member 1730 may be fixed, and accordingly, the vertical positions of the pressure receiving portion 1710 connected to the second elastic member 1730, the shaft 1720, and the second stage 1220 connected to the shaft 1720 may be fixed. When the pressure receiving portion 1710 is pushed by the pressurizing portion 30 and is moved downwards, the length of the second elastic member 1730 may be reduced, and accordingly, the pressure receiving portion 1710 connected to the second elastic member 1730, the shaft 1720, and the second stage 1220 connected to the shaft 1720 may be moved downwards. The length of the second elastic member 1730 may be reduced due to the pressure receiving portion 1710, and accordingly, the second elastic member 1730 may function as a buffer against the pressure. In addition, when the pressurization by the pressurizing portion 30 is completed, the length of the second elastic member 1730 may be extended back to the original length, and accordingly, the pressure receiving portion 1710, the shaft 1720, and the second stage 1220 may return back to their respective initial positions. In an embodiment, the second elastic member 1730 may include a cylinder. In such an embodiment, when the cylinder is driven by fluid pressure or a motor, the length of the cylinder may be extended or reduced. As such, the second stage 1220 may be driven vertically by the stage driving portion 1700, and for example, the second stage 1220 may be moved downward towards the first stage 1120 such that the second substrate S2 loaded at the second stage 1220 is bonded to the first substrate S1 loaded at the first stage 1120.

The driving bellows 1740 may connect the pressure receiving portion 1710 with the bridge portion 1500, and bridge portion 1500 with the second housing 1210, and may accommodate the shaft 1720 therein. The driving bellows 1740 may be contracted or extended between the pressure receiving portion 1710 and the bridge portion 1500 according to the movement of the pressure receiving portion 1710, and may seal a space between the pressure receiving portion 1710 and the bridge portion 1500. In an embodiment, the driving bellows 1740 may be contacted or extended between the bridge portion 1500 and the second housing 1210, and may seal a space between the bridge portion 1500 and the second housing 1210.

In an embodiment, although it is not shown in the drawings, the first unit 10 may further include a vision portion. The vision portion may obtain an image of the first stage 1120 and the second stage 1220 before the first stage 1120 and the second stage 1220 move for bonding of the first substrate S1 and the second substrate S2. The first chamber 1100 may further include an alignment portion 1130 connected to the first stage 1120 and align the position of the first stage 1120 to match with the position of the second stage 1220 based on the image obtained by the vision portion. In an embodiment, the alignment portion 1130 may move the first stage 1120 in the first direction (e.g., x direction of FIG. 4) or in the second direction (e.g., y direction of FIG. 4) or rotate the first stage 1120 on a plane (e.g., xy plane of FIG. 4.)

With reference back to FIG. 1, the pressurizing portion 30 may be arranged apart from the first unit 10 in the first direction (e.g., x direction of FIG. 1.) When the first unit 10, more specifically, the first support portion 1300, is moved such that the first unit 10 is below the pressurizing portion 30, the pressurizing portion 30 may move towards the second chamber 1200 to pressurize the second chamber 1200. As described above, the pressurizing portion 30 may pressurize the pressure receiving portion 1710 of the second chamber 1200, and accordingly, the second stage 1220 may move towards the first stage 1120, and the second substrate S2 and the first substrate S1 loaded at the second stage 1220 and the first stage 1120, respectively may be bonded to each other. In an embodiment, the pressurizing portion 30 may be driven and moved vertically by a robot arm or by fluid pressure.

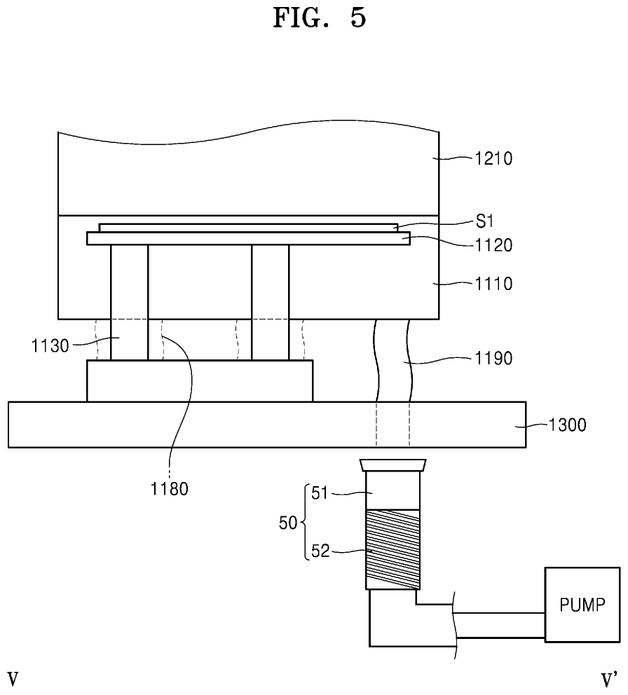

FIG. 5 is a schematic view taken along line V-V′ of FIG. 1 to illustrate a vacuum portion according to an embodiment. FIG. 5 illustrates a case where the first unit 10 is moved to the second position and located between the pressurizing portion 30 and the vacuum portion 50 for convenience of description.

With reference to FIG. 5, the vacuum portion 50 may vertically face the pressurizing portion 30. More specifically, the vacuum portion 50 may be integrated within the support driving portion 40 under the pressurizing portion 30 or may be arranged separately from the support driving portion 40. In an embodiment, the vacuum portion 50 may be docked to the first chamber 1100. In such an embodiment, when the first unit 10 is moved to the second position, the first unit 10, more particularly, the first chamber 1100, may be arranged on the vacuum portion 50. In such an embodiment, the first support portion 1300 may include a through hole, and the vacuum portion 50 may be docked to the through hole. The through hole may be connected to a first vacuum path 1190, and the first vacuum path 1190 may be connected to the first housing 1110. In an embodiment, a vacuum bellows 1180 for accommodating the alignment portion 1130 may be arranged under the first housing 1110. The vacuum bellows 1180 may accommodate the alignment portion 1130 therein and may seal a space between the first housing 1110 and the alignment portion 1130. Accordingly, when the vacuum portion 50 sucks gas to form a vacuum, the gas in the first housing 1110 is sucked through the first vacuum path 1190, and the vacuum may be formed inside the first housing 1110. As such, the vacuum portion 50 may be docked to the first chamber 1100 through the first vacuum path 1190 to form a vacuum, and be undocked from the first chamber 1100 when the vacuum is formed.

In an embodiment, the vacuum portion 50 may include a vacuum tube 51 and a bellows 52. The vacuum tube 51 may extend in one direction and may be connected to a vacuum pump. The bellows 52 may be arranged between parts of the vacuum tube 51. As the length of the bellows 52 is variable, the length of the bellows 52 may be extended such that the vacuum portion 50 is docked to the first chamber 1100 or may be reduced vertically such that the vacuum portion 50 is undocked from the first chamber 1100.

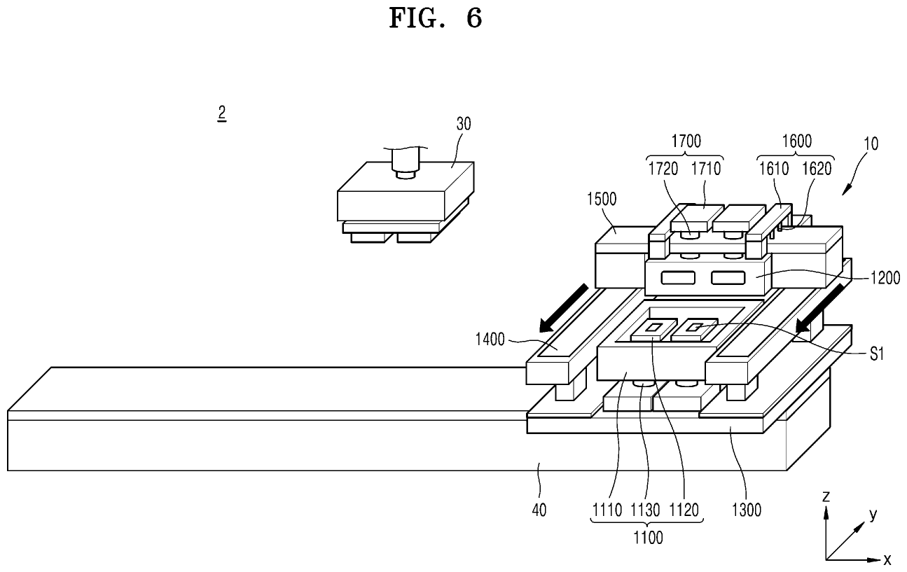

FIGS. 6 to 8 are schematic diagrams illustrating a method of manufacturing a display device, according to an embodiment. A method of manufacturing a display device according to an embodiment may be a method using the aforementioned apparatus for manufacturing a display device 2, more particularly, a lamination device; however, the disclosure is not limited thereto, and the method may be implemented may other devices within the technical ideas of the disclosure.

With reference to FIG. 6, in an embodiment of an apparatus for manufacturing a display device, the first unit 10 may be arranged apart from the pressurizing portion 30 in the first direction. More specifically, the first unit 10 may be in the first position. The first position may refer to a substrate supplying position at which the first unit 10 is arranged apart from the pressurizing portion 30 in the first direction. In the first position, the first unit 10 may receive objects (e.g., substrates) to be bonded. In an embodiment, for example, the first substrate S1 may be loaded at the first chamber 1100, and the second substrate S2 may be loaded at the second chamber 1200. In this case, the first chamber 1100 and the second chamber 1200 may be located at the first chamber position. The first chamber position is a position at which the second chamber 1200 does not overlap the first chamber 1100 in a plan view, that is, a position at which the second chamber 1200 is arranged apart from the first chamber 1100 in the second direction (e.g., y direction of FIG. 6.) Accordingly, the first substrate S1 may be adsorbed and loaded to the first stage 1120, and the second substrate S2 may be adsorbed and loaded to the second stage 1220. The loading of the first substrate S1 and the second substrate S2 may be performed simultaneously. As described above, the first substrate S1 may be one of a display panel for a display device, a metal plate, and an adhesive film, and the second substrate S2 may be one of a cover window for a display device, an adhesive film, and a display panel. Hereinafter, embodiments where the first substrate S1 is a display panel, and the second substrate S2 is a cover window will be described in detail for convenience of description.

In an embodiment, after the first substrate S1 and the second substrate S2 are loaded at the first chamber 1100 and the second chamber 1200, respectively, the second chamber 1200 may move in the second direction to the second chamber position. The second chamber position may be a position at which the second chamber 1200 overlaps with the first chamber 1100 in a plan view, that is, a position at which the second chamber 1200 is arranged on the first chamber 1100. More specifically, the second chamber 1200 may be connected to the bridge portion 1500, and the bridge portion 1500 may move in the second direction as the chamber driving portion 1400 extending in the second chamber 1200 is driven.

The vision portion may obtain an image of the positions of the first stage 1120 at which the first substrate S1 is loaded and the second stage 1220 at which the second substrate S2 is loaded. Based on the obtained image, the alignment portion 1130 of the first chamber 1100 may adjust a position of the first stage 1120 on a plane (e.g., xy plane of FIG. 6) to match with the position of the second stage 1220.

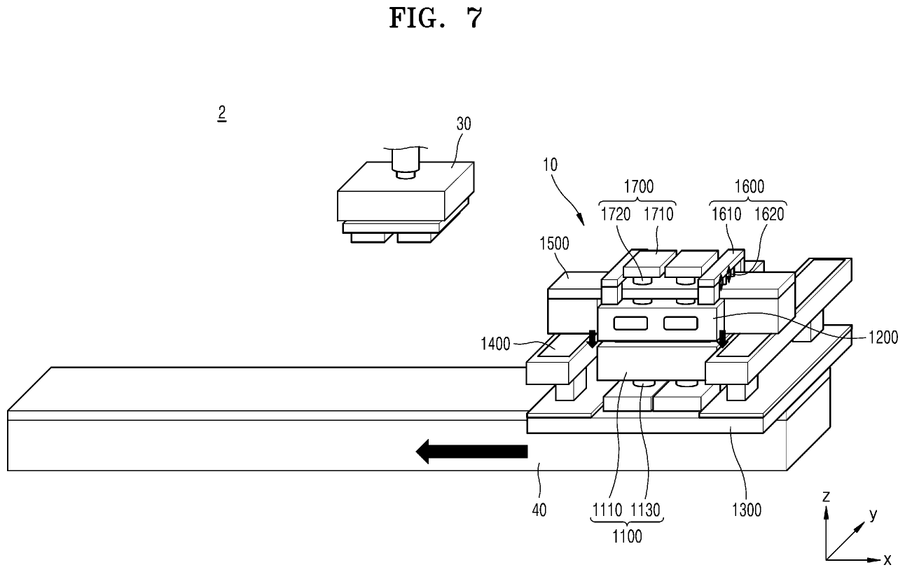

With reference to FIG. 7, in the second chamber position, the first chamber 1100 and the second chamber 1200 may overlap in a plan view, and the housing driving portion 1600 may be driven such that the second housing 1210 moves towards the first housing 1110, and a space between the first housing 1110 and the second housing 1210 may be sealed. In this case, only the second housing 1210 is moved downwards to form a seal, as illustrated with reference to FIG. 3 while the second stage 1220 arranged inside the second housing 1210 is not moved vertically.

Next, the first unit 10 may move towards the second position. The second position may be a bonding position at which the first unit 10 is moved to overlap the pressurizing portion 30 in a plan view. In an embodiment, the first unit 10 may move towards the second position by driving the support driving portion 40 and moving the first unit 10 arranged on the support driving portion 40 in an extension direction of the support driving portion 40. In an embodiment, the support driving portion 40 may be driven to move the first unit 10 after the housing driving portion 1600 is driven to seal a space between the second housing 1210 and the first housing 1110, but the disclosure is not limited thereto. In an alternative embodiment, for example, after the support driving portion 40 is driven to move the first unit 10 to the second position, the housing driving portion 1600 may be driven to form a seal between the second housing 1210 and the first housing 1110.

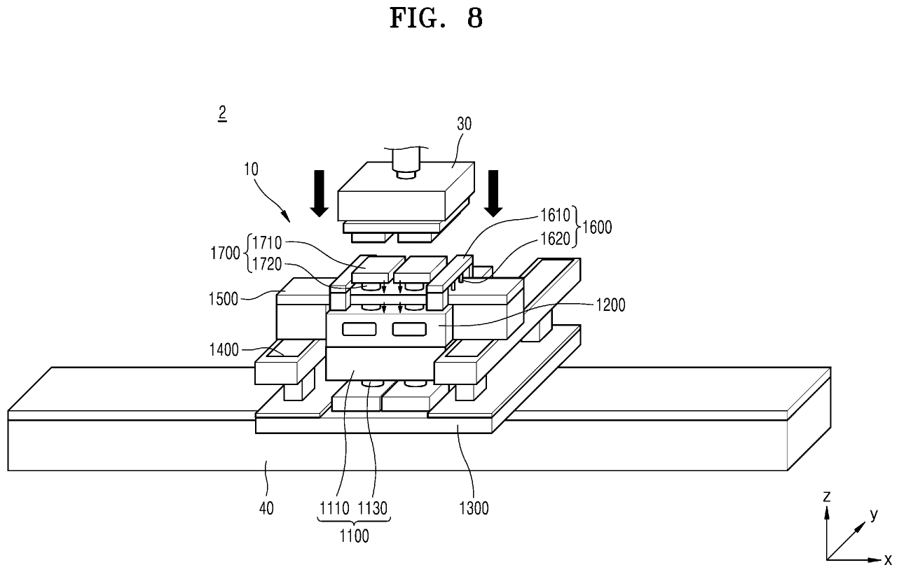

With reference to FIG. 8, after the first unit 10 is moved to the second position, the vacuum portion 50 may docked to the first chamber 1100. More specifically, the vacuum portion 50 may be docked to the first support portion 1300 as the length of the bellows 52 described above is extended. The vacuum portion 50 may be connected with the first housing 1110 of the first chamber 1100 through the through hole and the first vacuum path 1190 of the first support portion 1300. Then, the vacuum pump may be driven to form a vacuum inside the first housing 1110. At this time, as the first housing 1110 and the second housing 1210 are in contact with each other to form an internal space and form a seal together, the internal space in which the first stage 1120 and the second stage 1220 are arranged may be formed to be a vacuum.

Then, the pressurizing portion 30 may pressurize the second chamber 1200, more particularly, the pressure receiving portion 1710. Accordingly, as described with reference to FIG. 4, the shaft 1720 connected to the pressure receiving portion 1710 and the second stage 1220 connected to the shaft 1720 may be moved downwards. In this manner, the second substrate S2 loaded at the second stage 1220 and the first substrate S1 loaded at the first stage 1120 may be bonded to each other.

The bonded first substrate S1 and the second substrate S2 may be adsorbed by the first stage 1120 or the second stage 1220, and the first unit 10 may be moved to the first position of FIG. 6 by performing the operations illustrated in FIGS. 6 to 8 in reverse order. More specifically, the pressurizing portion 30 may move back upwards, and accordingly, the reduced length of the second elastic member 1730 may be extended such that the second stage 1220 may move back upwards.

Then, the vacuum portion 50 may be undocked from the first support portion 1300. The length of the bellows 52 of the vacuum portion 50 may be reduced again such that the vacuum portion 50 is released from the first support portion 1300.

The support driving portion 40 may be driven to move the first unit 10 back to the first position, and as the length of the first elastic member 1620 is extended again, the second housing 1210 may move upwards such that the seal between the second housing 1210 and the first housing 1110 is opened. Then, the chamber driving portion 1400 may be driven to move the second chamber 1200 from the second chamber position to the first chamber position. Accordingly, the first chamber 1100 and the second chamber 1200 may be move to a position in which they do not overlap each other on a plan view, and each of the first stage 1120 and the second stage 1220 may be exposed.

Then, the first substrate S1 and the second substrate S2 adsorbed by the first stage 1120 or the second stage 1220 may be released, and each of the first substrate S1 and the second substrate S2 may be provided to the first stage 1120 and the second stage 1220 again to repeat the operations described with reference to FIGS. 6 to 8.

According to embodiments of the method of manufacturing a display device using an apparatus for manufacturing the display device, as the first chamber 1100 and the second chamber 1200 move relatively with each other in the second direction, the first stage 1120 and the second stage 1220 may move to a position in which the first stage 1120 and the second stage 1220 do not overlap each other in a plane view. In this manner, the first substrate S1 and the second substrate S2 may be simultaneously loaded at the first stage 1120 and the second stage 1220, respectively.

In such embodiments, as the pressurizing portion 30 and the vacuum portion 50 are arranged apart from the chambers, a space for maintenance of the apparatus for manufacturing of a display device may be secured.

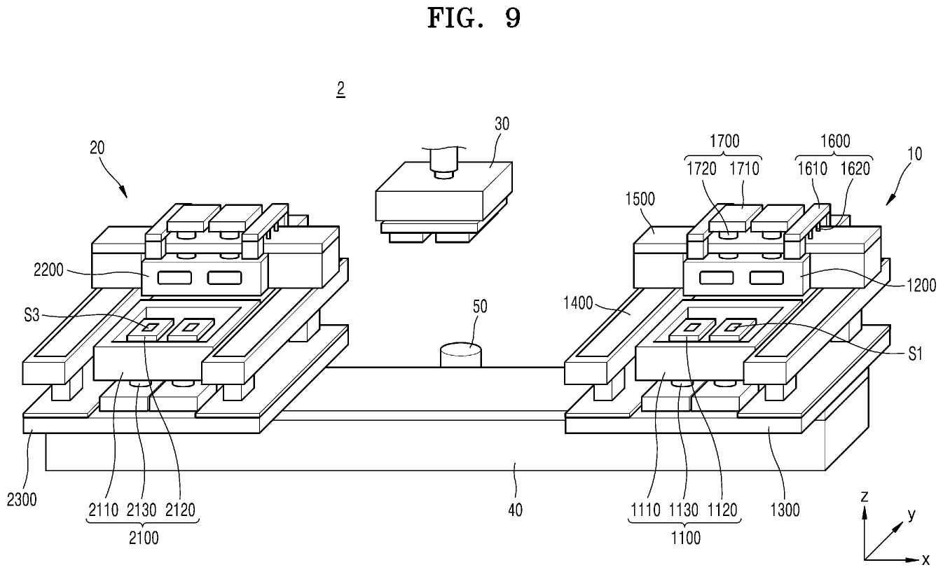

FIG. 9 is a schematic perspective view of an apparatus for manufacturing a display device, according to an alternative embodiment. As the embodiment of an apparatus for manufacturing a display device shown in FIG. 9 is similar to the embodiments of the apparatus for manufacturing a display device described above, differences therebetween are described in detail, and any repetitive detailed description of the same or like elements in FIG. 9 as those described above may be omitted or simplified.

With reference to FIG. 9, an embodiment of the apparatus for manufacturing a display device 2 may further include a second unit 20. The second unit 20 may be substantially the same as the first unit 10. That is, in an embodiment, the second unit 20 may include a second support portion 2300, a third chamber 2100 arranged on the second support portion 2300, and a fourth chamber 2200 on the third chamber 2100. The third chamber 2100 may load a third substrate S3 at a third stage 2110 of the third chamber 2100, and the fourth chamber 2200 may load a fourth substrate S4 at a fourth stage 2210 of the fourth chamber 2200. In an embodiment, the third substrate S3 may be the same as the first substrate S1, and the fourth substrate S4 may be the same as the second substrate S2. However, the disclosure is not limited thereto, and the second unit 20 may be a unit for bonding substrates that are different from the first unit 10. Hereinafter, embodiments where the third substrate S3 and the fourth substrate S4 are the same as the first substrate S1 and the second substrate S2, respectively, will be described. In addition, as the second unit 20 is substantially the same as the first unit 10, any repetitive detailed descriptions of the same elements of the second unit 20 as those of the first unit 10 described above are omitted.

The second unit 20 may be arranged on a side opposite to the first unit 10 with respect to the pressurizing portion 30. In an embodiment, the second unit 20 may be arranged symmetrical with the first unit 10 with respect to the pressurizing portion 30. The first unit 10 and the second unit 20 may alternately move towards the pressurizing portion 30, and be pressurized by the pressurizing portion 30 to bond the substrates. This may be further described in detail with reference to the method of manufacturing a display device.

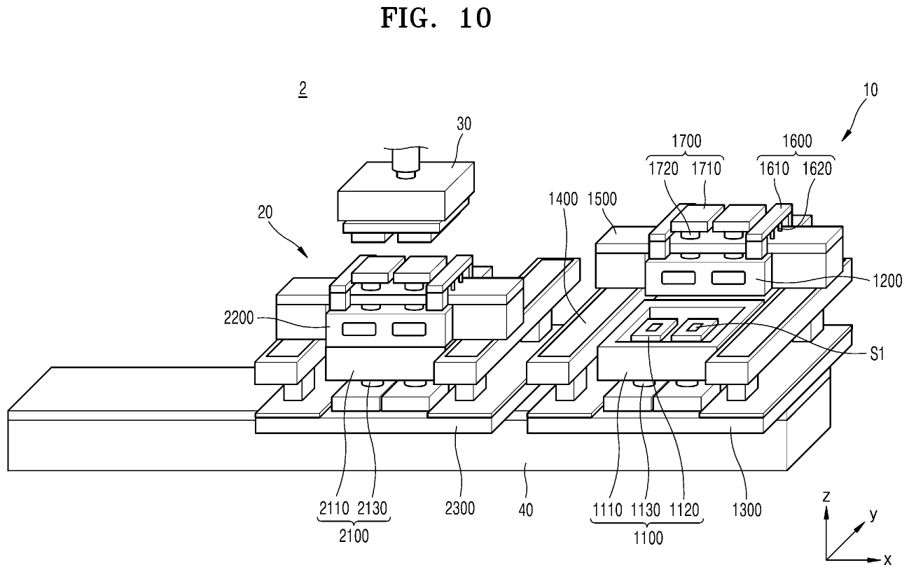

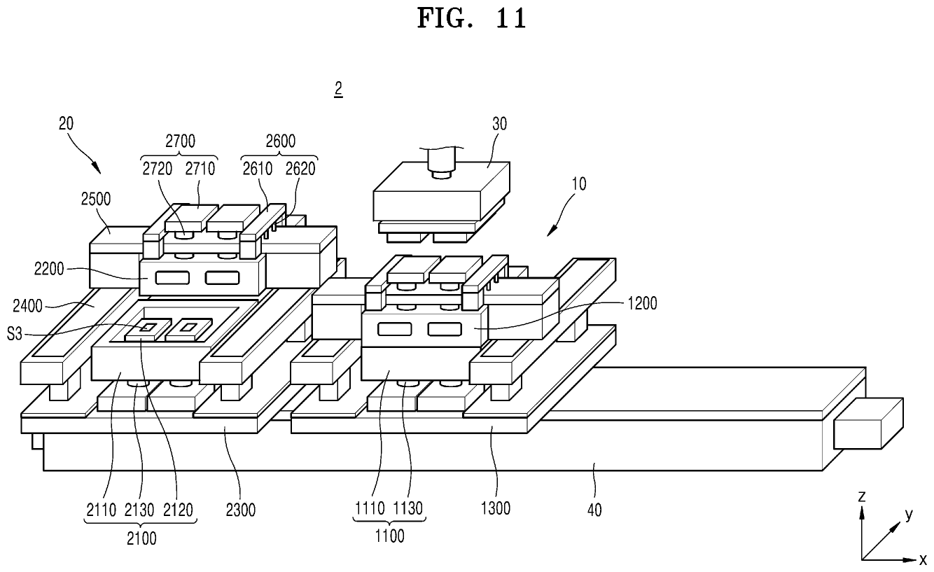

FIGS. 10 and 11 are schematic diagrams illustrating a method of manufacturing a display device, according to an alternative embodiment. A method of manufacturing a display device according to an embodiment may be a method using the apparatus for manufacturing a display device shown in FIG. 9, more particularly, a lamination device; however, the disclosure is not limited thereto, and the method may be implemented may other devices within the technical ideas of the disclosure. As a method of manufacturing a display device according to the embodiment of FIGS. 10 and 11 is similar to the aforementioned method of manufacturing a display device, differences therebetween are described in detail.

With reference to FIG. 10, the first unit 10 may be arranged apart from the pressurizing portion 30 in the first direction. More specifically, the first unit 10 may be in the first position. The second unit 20 may move from a third position to the second position. The third position may be a position of the second unit 20 corresponding to the first position of the first unit 10, and may refer to, for example, a position symmetric with the first position in the first direction with respect to the pressurizing portion 30. That is, the third position may refer to a substrate supplying position at which the second unit 20 is arranged apart from the pressurizing portion 30 in the first direction.

As described above, the substrate may be loaded to the first unit 10. In an embodiment, for example, the first substrate S1 may be loaded at the first chamber 1100, and the second substrate S2 may be loaded at the second chamber 1200. The vacuum portion 50 may be docked to the second unit 20 at the second position to form a vacuum at an internal space of the third chamber 2100 and the fourth chamber 2200, and the third chamber 2100 and the fourth chamber 2200 may be pressurized by the pressurizing portion 30 such that the substrates loaded at the third chamber 2100 and the fourth chamber 2200 may be bonded to each other.

With reference to FIG. 11, in the first unit 10, after the substrates are loaded, the second chamber 1200 may move to the second chamber position and be aligned with the first chamber 1100 to form a seal. Then, the first unit 10 may move from the first position to the second position.

After the second unit 20 is pressurized by the pressurizing portion 30 to bond the substrates, the vacuum portion 50 may be undocked, and the second unit 20 may move from the second position to the third position.

As described above, as the second position, the first unit 10 may be pressurized by the pressurizing portion 30 and the bonding of the substrates may be performed. More specifically, the vacuum portion 50 may be docked to the first unit 10 at the second position to form a vacuum at an internal space of the first chamber 1100 and the second chamber 1200, and the first chamber 1100 and the second chamber 1200 may be pressurized by the pressurizing portion 30 such that the substrates loaded at the first chamber 1100 and the second chamber 1200 may be bonded to each other. The pressurizing portion 30 may pressurize the pressure receiving portion 1710, and accordingly, the second stage 1220 may be moved towards the first stages 1120 such that the first substrate S1 and the second substrate S2 are bonded to each other.

In the second unit 20 located in the third position, the fourth chamber 2200 may be moved from the second chamber position to the first chamber position. A described above, the first chamber position is a position at which the fourth chamber 2200 does not overlap the third chamber 2100 on a plan view, that is, a position at which the fourth chamber 2200 is arranged apart from the third chamber 2100 in the second direction. The second chamber position may be a position at which the fourth chamber 2200 overlaps the third chamber 2100 on a plan view, that is, a position at which the fourth chamber 2200 is arranged on the third chamber 2100. Accordingly, the third chamber 2100 and the fourth chamber 2200 may be move to a position in which the third chamber 2100 and the fourth chamber 2200 do not overlap each other in a plan view, and each of the third stage 2110 and the fourth stage 2210 may be exposed.

A bonded object adsorbed by the third stage 2110 or the fourth stage 2210, for example, the third substrate S3 and the fourth substrate S4 bonded to each other, may be discharged, and the third substrate S3 and the fourth substrate S4 may be provided again to the third stage 2110 and the fourth stage 2210, respectively.

When the bonding of the substrates is completed, the first unit 10 may move back to the first position. When the bonding of the substrates is completed, the second unit 20 may move back to the second position. Then, the operations described with reference to FIGS. 10 and 11 may be repeated.

The apparatus for manufacturing a display device and the method of manufacturing a display device according to an embodiment may improve space efficiency of the apparatus for manufacturing a display device by including the pressurizing portion 30 and the vacuum portion 50 for the first unit 10 and the second unit 20. In such an embodiment, a space for maintenance of the apparatus for manufacturing a display device may be secured. In such an embodiment, as the second unit 20 bonds the substrates while the first unit 10 discharges and loads the substrates, and the first unit 10 bonds the substrates while the second unit 20 discharges and loads the substrates, the process time and efficiency may be improved.

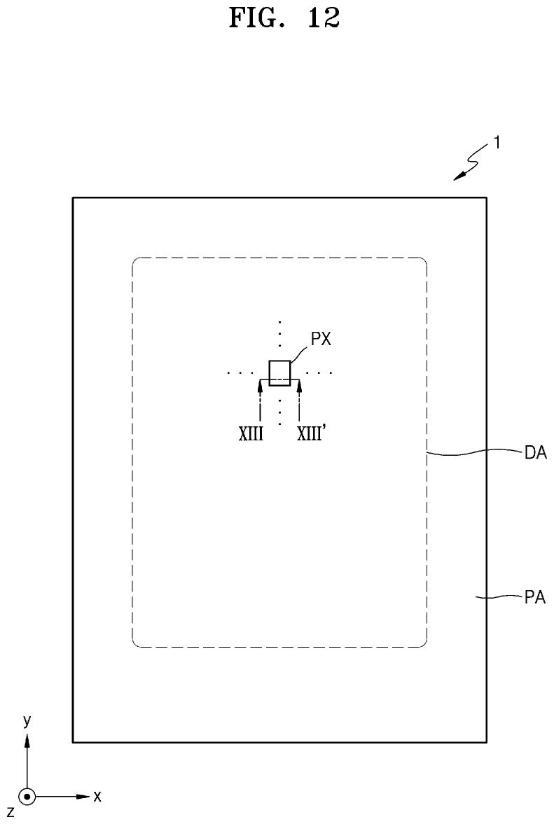

FIG. 12 is a plan view schematically illustrating a display device according to an embodiment. In an embodiment, a display device may be a display device manufactured by a method of manufacturing a display device using an apparatus for manufacturing a display device according to an embodiment.

With reference to FIG. 12, a display device 1 manufactured according to an embodiment may include a display area DA and a peripheral area PA outside the display area DA. The display device 1 may provide an image through an array of a plurality of pixels PX that are arranged in a two-dimensional (2D) manner in the display area DA.

The peripheral area PA where no image is provided therefrom may entirely or partially surround the display area DA. In the peripheral area PA, a driver, etc. to provide an electrical signal or power to a pixel circuit corresponding to each of the pixels PX may be provided. A pad to which an electronic device or a printed circuit board may be electrically connected may be arranged in the peripheral area PA.

Hereinafter, embodiments where the display device 1, includes an organic light-emitting diode (OLED) as a light-emitting element; however, the display device 1 of the disclosure is not limited thereto. In an alternative embodiment, the display device 1 may be a light-emitting display device including an inorganic light-emitting diode, i.e., an inorganic light-emitting display device. The inorganic light-emitting diode may include a PN diode including inorganic semiconductor-based materials. When a voltage is applied in a forward direction to a PN junction diode, holes and electrons are injected, and energy generated due to recombination of the holes and the electrons may be converted into light energy to emit light of a certain color. The inorganic light-emitting diode may have a width ranging from several to hundreds of micrometers, and in some embodiments, the inorganic light-emitting diode may be referred to as a micro-light-emitting diode (LED). In another alternative embodiment, the display device 1 may be a quantum dot light-emitting display device.

The display device 1 may be used as a display of various products or electronic devices, such as mobile electronic device including a mobile phone, a smartphone, a table personal computer (PC), a mobile communication terminal, an electronic notebook, an electronic book, a portable multimedia player (PMP) as well as a navigation, an ultra mobile PC (UMPC), and a television, a laptop, a monitor, a signboard, an internet of things (IOT) device, etc. In addition, the display device 1 may be used in wearable devices including smartwatches, watchphones, glasses-type displays, and head-mounted displays (HMD). In addition, the display device 1 may be used as instrument panels for automobiles, center fascias for automobiles, or center information displays (CID) arranged on a dashboard, room mirror displays that replace side mirrors of automobiles, and displays arranged on the backside of front seats as an entertainment for back seats of automobiles.

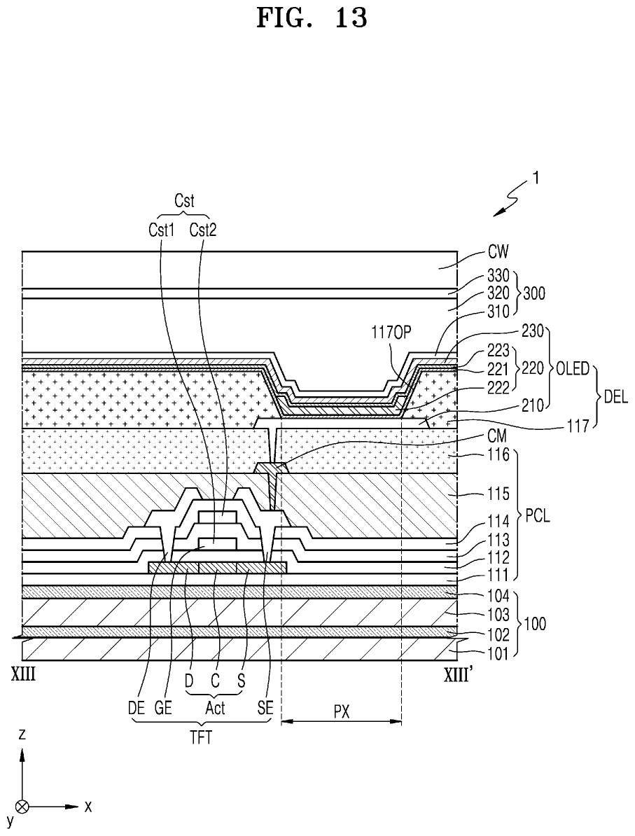

FIG. 13 is a schematic cross-sectional view of a display device manufactured using an apparatus for manufacturing a display device according to an embodiment, which may correspond to the cross-section of a display device taken along line XIII-XIII′ of FIG. 12.

With reference to FIG. 13, an embodiment of the display device 1 may include a substrate 100, a pixel circuit layer PCL, a display element layer DEL, and an encapsulation layer 300.

The substrate 100 may have a multi-layer structure including a base layer including polymer resin and an inorganic layer. In an embodiment, for example, the substrate 100 may include a base layer including polymer resin and a barrier layer, which is an inorganic insulating layer. In an embodiment, for example, the substrate 100 may include a first base layer 101, a first barrier layer 102, a second base layer 103, and a second barrier layer 104, which are sequentially stacked. The first base layer 101 and the second base layer 103 may include polyimide (PI), polyethersulfone (PES), polyarylate, polyetherimide (PEI), polyethyelene napthalate (PEN), polyethyleneterephthalate (PET), polyphenylene sulfide (PPS), polycarbonate (PC), cellulose triacetate (TAC), and/or cellulose acetate propionate (CAP). The first barrier layer 102 and the second barrier layer 104 may include an inorganic insulating material such as silicon oxide, silicon oxynitride, and/or silicon nitride. The substrate 100 may be flexible.

The pixel circuit layer PCL may be arranged on the substrate 100. FIG. 13 illustrates an embodiment where the pixel circuit layer PCL includes a thin-film transistor TFT and a buffer layer 111, a first gate insulating layer 112, a second gate insulating layer 113, an interlayer insulating layer 114, a first planarization insulating layer 115, and a second planarization insulating layer 116, which are arranged under or on the components of the thin-film transistor TFT.

The buffer layer 111 may reduce or prevent penetration of a foreign material, moisture, or external air from the bottom of the substrate 100 and may planarize the substrate 100. The buffer layer 111 may include an inorganic insulating material such as silicon oxide, silicon oxynitride, or silicon, and may have a single or multi-layer structure, each layer therein including at least one selected from the above materials.

The thin-film transistor TFT on the buffer layer 111 may include a semiconductor layer Act, and the semiconductor layer Act may include polysilicon. Alternatively, the semiconductor layer Act may include amorphous silicon, may include an oxide semiconductor, or may include an organic semiconductor or the like. The semiconductor layer Act may include a channel area C and a drain area D and a source area S that are arranged on opposing sides of the channel area C. A gate electrode GE may be disposed to overlap the channel area C.

The gate electrode GE may include a low-resistance metal material. The gate electrode GE may include a conductive material including molybdenum (Mo), aluminum (Al), copper (Cu) or titanium (Ti), for example. and may have a single or multi-layer structure, each layer therein including at least one selected from the above materials.

The first gate insulating layer 112 between the semiconductor layer Act and the gate electrode GE may include an inorganic insulating material such as SiO₂, SiN_{X}, SiON, aluminum oxide (Al₂O₃), titanium oxide (TiO₂), tantalum oxide (Ta₂O₅), hafnium oxide (HfO₂), or zinc oxide (ZnO_{X}). Here, zinc oxide (ZnO_{X}) may be zinc oxide (ZnO) and/or zinc peroxide (ZnO₂).

The second gate insulating layer 113 may cover the gate electrode GE. Similar to the first gate insulating layer 112, the second gate insulating layer 113 may include an inorganic insulating material such as SiO₂, SiN_{X}, SiON, aluminum oxide (Al₂O₃), titanium oxide (TiO₂), tantalum oxide (Ta₂O₅), hafnium oxide (HfO₂), or zinc oxide (ZnO_{X}). Here, zinc oxide (ZnO_{X}) may be zinc oxide (ZnO) and/or zinc peroxide (ZnO₂).

An upper electrode Cst2 of a storage capacitor Cst may be arranged on the second gate insulating layer 113. The upper electrode Cst2 may be disposed to overlap the gate electrode GE thereunder. In such an embodiment, the gate electrode GE and the upper electrode Cst2, which overlap each other with the second gate insulating layer 113 therebetween, may form the storage capacitor Cst. That is, the gate electrode GE may function as a lower electrode Cst1 of the storage capacitor Cst.

As described, the storage capacitor Cst and the thin film transistor TFT may overlap each other. In some embodiments, the storage capacitor Cst may not overlap the thin film transistor TFT.

The upper electrode Cst2 may include aluminum (Al), platinum (Pt), palladium (Pd), silver (Ag), magnesium (Mg), gold (Au), nickel (Ni), neodymium (Nd), iridium (Ir), chromium (Cr), calcium (Ca), molybdenum (Mo), titanium (Ti), tungsten (W), and/or copper (Cu) and may have a single or multi-layer structure, each layer therein including at least one selected from the above materials.

The interlayer insulating layer 114 may cover the upper electrode Cst2. The interlayer insulating layer 114 may include silicon oxide (SiO₂), silicon nitride (SiN_{X}), silicon oxynitride (SiON), aluminum oxide (Al₂O₃), titanium oxide (TiO₂), tantalum oxide (Ta₂O₅), hafnium oxide (HfO₂), or zinc oxide (ZnO_{X}). Here, zinc oxide (ZnO_{X}) may be zinc oxide (ZnO) and/or zinc peroxide (ZnO₂). The interlayer insulating layer 114 may have a single or multi-layer structure, each layer therein including at least one selected from the above inorganic insulating materials.

A drain electrode DE and a source electrode SE may each be arranged on the interlayer insulating layer 114. Each of the drain electrode DE and the source electrode SE may be connected to the drain area D and the source area S through a contact hole defined or formed in lower insulating layers thereunder. The drain electrode DE and the source electrode SE may include materials having high conductivity. The drain electrode DE and the source electrode SE may include conductive materials such as Mo, Al, Cu or Ti and may have a single or multi-layer structure, each layer therein including at least one selected from the above materials. In an embodiment, the drain electrode DE and the source electrode SE may have a multi-layer structure of Ti/Al/Ti.

The first planarization insulating layer 115 may cover the drain electrode DE and the source electrode SE. The first planarization insulating layer 115 may include an organic insulating material including a general-purpose polymer such as polymethylmethacrylate (PMMA) or polystyrene (PS), polymer derivatives having a phenol-based group, an acryl-based polymer, an imide-based polymer, an aryl ether-based polymer, an amide-based polymer, a fluorine-based polymer, a p-xylene-based polymer, a vinyl alcohol-based polymer, or a blend thereof.

The second planarization insulating layer 116 may be arranged on the first planarization insulating layer 115. The second planarization insulating layer 116 may include the same material as the first planarization insulating layer 115, and may include an organic insulating material including a general-purpose polymer such as polymethylmethacrylate (PMMA) or polystyrene (PS), polymer derivatives having a phenol-based group, an acryl-based polymer, an imide-based polymer, an aryl ether-based polymer, an amide-based polymer, a fluorine-based polymer, a p-xylene-based polymer, a vinyl alcohol-based polymer, or a blend thereof.

In an embodiment, the display element layer DEL may be arranged on the pixel circuit layer PCL described above. The display element layer DEL may include an OLED as a display element (i.e., a light-emitting element), and the OLED may include a stacked structure of a pixel electrode 210, an intermediate layer 220, and a common electrode 230. The OLED may emit, for example, red light, green light, or blue light or may emit red light, green light, blue light, or white light. The OLED may emit light through an emission area and the emission area may be defined as the pixel PX.

The pixel electrode 210 of the OLED may be electrically connected to the thin-film transistor TFT through the contact holes defined or formed in the second planarization insulating layer 116 and the first planarization insulating layer 115 and a contact metal CM arranged on the first planarization insulating layer 115.

In an embodiment, the pixel electrode 210 may include conductive oxide such as indium tin oxide (ITO), indium zinc oxide (IZO), zinc oxide (ZnO), indium oxide (In₂O₃), indium gallium oxide (IGO), or aluminum zinc oxide (AZO). In an alternative embodiment, the pixel electrode 210 may include a reflective layer including Ag, Mg, Al, Pt, Pd, Au, Ni, Nd, Ir, Cr, or a compound thereof. In another alternative embodiment, the pixel electrode 210 may further include a layer including ITO, IZO, ZnO, or In₂O₃ on/under the above reflective layer.

A pixel-defining layer 117 with an opening 1170P defined therethrough to expose a central portion of the pixel electrode 210 may be arranged on the pixel electrode 210. The pixel-defining layer 117 may include an organic insulating material and/or an inorganic insulating material. The opening 1170P may define an emission area of light emitted from the OLED. In an embodiment, for example, a size/width of the opening 1170P may correspond to a size/width of the emission area. Accordingly, a size and/or a width of the pixel PX may be determined based on the size and/or the width of the corresponding opening 1170P of the pixel-defining layer 117.

The intermediate layer 220 may include an emission layer 222 formed to correspond to the pixel electrode 210. The emission layer 222 may include a high-molecular or low-molecular weight organic material emitting light of a certain color. Alternatively, the emission layer 222 may include an inorganic light-emitting material or include a quantum dot.

In an embodiment, for example, the intermediate layer 220 may include a first functional layer 221 and a second functional layer 223 respectively arranged under and on the emission layer 222. The first functional layer 221 may include, for example, a hole transport layer (HTL) or include an HTL and a hole injection layer (HIL). The second functional layer 223 may be a component arranged on the emission layer 222 and include an electron transport layer (ETL) and/or an electron injection layer (EIL). The first functional layer 221 and/or the second functional layer 223 may be common layers that entirely cover the substrate 100 as the common electrode 230 described below entirely covers the substrate 100.

The common electrode 230 may be arranged on the pixel electrode 210 and overlap with the pixel electrode 210. The common electrode 230 may include a conductive material having a low work function. In an embodiment, for example, the common electrode 230 may include a transparent (translucent) layer including Ag, Mg, Al, Pt, Pd, Au, Ni, Nd, Ir, Cr, Li, Ca, or an alloy thereof. Alternatively, the common electrode 230 may further include a layer including ITO, IZO, ZnO, or In₂O₃ on the transparent (translucent) layer including the above material(s). The common electrode 230 may be formed on an integrated manner to entirely cover the substrate 100.

The encapsulation layer 300 may be arranged on the display element layer DEL and cover the display element layer DEL. The encapsulation layer 300 may include at least one inorganic encapsulation layer and at least one organic encapsulation layer. In an embodiment, as shown in FIG. 13, the encapsulation layer 300 includes a first inorganic encapsulation layer 310, an organic encapsulation layer 320, and a second inorganic encapsulation layer 330 that are sequentially stacked.

The first inorganic encapsulation layer 310 and the second inorganic encapsulation layer 330 may include at least one inorganic material from aluminum oxide, titanium oxide, tantalum oxide, hafnium oxide, zinc oxide, silicon oxide, silicon nitride, and silicon oxynitride. The organic encapsulation layer 320 may include a polymer-based material. Examples of the polymer-based material may include an acrylic resin, an epoxy resin, polyimide, and polyethylene. In an embodiment, the organic encapsulation layer 320 may include acrylate. The organic encapsulation layer 320 may be formed by curing a monomer or coating a polymer. The organic encapsulation layer 320 may be transparent.

Although it is not shown in the drawings, a touch sensor layer may be arranged on the encapsulation layer 300, and an optical functional layer may be arranged on the touch sensor layer. The touch sensor layer may obtain coordinate information based on an external input, for example, a touch event. The optical functional layer may reduce reflexibility of light (external light) incident towards the display device from the outside and/or improve color purity of light emitted from the display device. In an embodiment, the optical functional layer may include a phase retarder and/or a polarizer. The phase retarder may be of a film type or a liquid crystal coating type and may include a λ/2 phase retarder and/or a λ/4 phase retarder. The polarizer may include a film-type polarizer or a liquid crystal-type polarizer. The film-type polarizer may include a stretchable synthetic resin film, and the liquid crystal-type polarizer may include liquid crystals arranged in a certain array. The phase retarder and the polarizer may further include a protective film.

An adhesive member may be arranged between the touch sensor layer and the optical functional layer. Any common adhesive member known to the technical field may be employed without limitation as the adhesive member. The adhesive member may include a pressure sensitive adhesive (PSA).

A cover window CW may be arranged on the encapsulation layer 300, and when the touch sensor layer and/or the optical functional layer is provided, the cover window CW may be arranged on the touch sensor layer and/or the optical functional layer. The cover window CW may include at least one selected from glass, sapphire, and plastic. The cover window CW may be, for example, ultra thin glass or colorless polyimide. In an embodiment, the cover window CW may have a structure in which a polymer layer having flexibility is arranged on one side of a glass substrate or may only include a polymer layer.

The cover window CW may be attached by an adhesive member (not shown). The adhesive member may be optically clear resin (OCR) or optically clear adhesive (OCA) and/or pressure sensitive adhesive (PSA).

According to embodiments of the disclosure, an apparatus for manufacturing a display device and a method of manufacturing a display device which facilitate simplification of process of loading and releasing the substrate and quick bonding of multiple substrates may be implemented.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. An apparatus for manufacturing a display device, the apparatus comprising:
a pressurizing portion; and
a first unit arranged apart from the pressurizing portion in a first direction when the first unit is in a first position,
wherein the first unit comprises:
a first support portion movable in the first direction;
a first chamber arranged on the first support portion, wherein a first substrate is loaded in the first chamber; and
a second chamber arranged on the first chamber, wherein a second substrate is loaded in the second chamber, and
wherein the first support portion moves between the first position in which the first support portion is apart from the pressurizing portion in the first direction and a second position in which the first support portion and the pressurizing portion overlap each other in a plan view.

2. The apparatus of claim 1, wherein, when the first support portion is in the first position, the first substrate and the second substrate are simultaneously loaded to the first chamber and the second chamber, respectively.

3. The apparatus of claim 1, wherein, when the first support portion is in the second position, the pressurizing portion applies pressure to at least one selected from the first chamber and the second chamber.

4. The apparatus of claim 2, further comprising:
a vacuum portion arranged apart from the first unit in the first direction,
wherein, when the first support portion is in the second position, the vacuum portion is docked to the first chamber.

5. The apparatus of claim 4, wherein, when the first support portion is in the first position, the vacuum portion is undocked from the first chamber.

6. The apparatus of claim 1, wherein the first chamber and the second chamber moves relatively with respect to each other from a first chamber position, in which the first chamber and the second chamber do not overlap each other in the plan view, to a second chamber position, in which the first chamber and the second chamber overlap each other in the plan view.

7. The apparatus of claim 6, wherein the first substrate and the second substrate are loaded to or released from the first chamber and the second chamber, respectively, when the first chamber and the second chamber are in the first chamber position.

8. The apparatus of claim 6, wherein the first unit further comprises:
chamber driving portions respectively arranged on opposing sides of the first chamber; and
a bridge portion extending between the chamber driving portions and connected to the chamber driving portions,
wherein the second chamber is connected to the bridge portion and is moved vertically with respect to the bridge portion to form a sealed space together with the first chamber when the first chamber and the second chamber are in the second chamber position.

9. The apparatus of claim 1, further comprising:
a second unit arranged opposite to the first unit with respect to the pressurizing portion,
wherein the first unit and the second unit alternately move towards the pressurizing portion in a way such that the second unit is in a third position in which the second unit is located apart from the pressurizing portion when the first unit is in the first position, and the second unit is in a fourth position in which the second unit overlaps the pressurizing portion in the plan view when the first unit is in the second position.

10. The apparatus of claim 9, wherein the second unit comprises:
a second support portion movable in the first direction;
a third chamber arranged on the second support portion, wherein a third substrate is loaded in the third chamber; and
a fourth chamber arranged on the third chamber, wherein a fourth substrate is loaded in the fourth chamber, and
when the first support portion is in the second position, the second support portion is in the third position.

11. The apparatus of claim 10, wherein
the first unit is pressurized by the pressurizing portion when the first support portion is in the second position, and
the third substrate and the fourth substrate are simultaneously loaded to the second unit when the second support portion is in the third position.

12. The apparatus of claim 9, further comprising:
a vacuum portion arranged apart from and between the first unit and the second unit,
wherein the first unit is docked to the vacuum portion and the second unit is undocked from the vacuum portion when the first unit is in the second position and the second unit is in the fourth position,
and the first unit is undocked from the vacuum portion and the second unit is docked to the vacuum portion when the first unit is in the first position and the second unit is in the third position.

13. A method of manufacturing a display device, the method comprising:
loading a plurality of substrates to be bonded to each other to a first unit in a first position, in which the first unit is located apart from a pressurizing portion in a first direction;
moving the first unit to a second position, in which the first unit and the pressurizing portion overlap each other in a plan view;
pressurizing, by the pressurizing portion, the first unit in the second position to bond the plurality of substrates to each other;
moving the first unit to the first position; and
releasing the plurality of substrates bonded to each other from the first unit in the first position, and re-loading a plurality of substrates to be bonded to the first unit in the first position.

14. The method of claim 13, wherein the loading the plurality of substrates to be bonded to each other to the first unit includes simultaneously loading the plurality of substrates to the first unit.

15. The method of claim 14, wherein
the first unit comprises a first chamber and a second chamber arranged on the first chamber,
the first chamber and the second chamber are located at a first chamber position, in which the first chamber and the second chamber do not overlap each other in the plan view, and the plurality of substrates are loaded simultaneously when the first chamber and the second chamber are in the first chamber position.

16. The method of claim 13, wherein
the first unit comprises a first chamber and a second chamber arranged on the first chamber, and
the first chamber and the second chamber are located at a second chamber position, in which the first chamber and the second chamber are disposed to overlap each other to seal a space therein.

17. The method of claim 16, wherein, when the first chamber and the second chamber are in the second chamber position, the pressurizing portion pressurizes the second chamber to bond the plurality of substrates loaded to the first chamber and the second chamber.

18. The method of claim 13, further comprising:
docking a vacuum portion to the first unit to form a vacuum inside the first unit in the second position.

19. The method of claim 13, further comprising:
pressurizing, by the pressurizing portion, a second unit in a third position, in which the second unit and the pressurizing portion overlap each other in the plan view, to bond a plurality of substrates loaded to the second unit during when the plurality of substrates to be bonded to each other are loaded to the first unit when the first unit is in the first position.

20. The method of claim 19, further comprising:
moving the second unit to a fourth position in which the second unit is located apart from the pressurizing portion during when the first unit is moved to the second position.

21. The method of claim 20, further comprising:
releasing the plurality of substrates bonded to each other from the second unit in the fourth position and re-loading a plurality of substrates to be bonded to the second unit during when the first unit in the second position is pressurized by the pressurizing portion.
